(19) United States
(12) Patent Application Publication
(10) Pub. No.: US 2024/0059876 A1
(43) Pub. Date: Feb. 22, 2024

(54) MODIFIED LOW DENSITY POLYETHYLENE RESINS AND METHOD FOR MAKING THE SAME

(71) Applicant: Dow Global Technologies LLC, Midland, MI (US)

(72) Inventors: Yifan Dong, Lake Jackson, TX (US); Santosh S. Bawiskar, Sugar Land, TX (US); Teresa P. Karjala, Lake Jackson, TX (US); Pradeep Jain, Missouri City, TX (US); Lori L. Kardos, Sugar Land, TX (US); Michael B. Biscoglio, Blue Bell, PA (US); John P. O'brien, Manvel, TX (US); Daniel W. Baugh, III, Lake Jackson, TX (US)

(21) Appl. No.: 18/260,278

(22) PCT Filed: Feb. 21, 2022
(86) PCT No.: PCT/US2022/017133

§ 371 Date: Jul. 3, 2023

Related U.S. Application Data
(60) Provisional application No. 63/151,356, filed on Feb. 19, 2021.

(51) Int. Cl. C08L 23/06; C08J 3/28

(52) U.S. Cl. CPC C08L 23/06; C08J 3/28; C08L 2203/14; C08L 2203/16; C08L 2203/30; C08L 2205/025; C08L 2207/062; C08L 2207/066

(57) ABSTRACT

Irradiation of low-density polyethylene resins with an electron beam produces modified polyethylene resins that have significantly improved melt strength and retain useful melt-index and have few cross-linked gels, if the starting LDPE resin and the level of irradiation are properly selected.

### TECHNICAL FIELD

This disclosure relates to low density polyethylene resins and processes to modify them to improve their physical properties.

### BACKGROUND

Low density polyethylene (LDPE) resins and processes to make them are well known and described in many publications, such as the following patents: U.S. Pat. Nos. 7,741,415 B2; 8,415,442 B2; 8,729,186 B2; 8,871,887 B2; 9,120,880 B2; 10,435,489 B2; 10,465,024 B2; 10,494,457 B2; WO 2010/144784; WO 2011/019563; WO 2012/082393; WO 2009/114661; U.S. Pat. Nos. 8,916,667; 9,303,107; and EP 2239283B1.

LDPE resins (also referred to as “high pressure ethylene polymer” or “highly branched polyethylene”) are ethylene polymers prepared using a free-radical, high pressure (≥100 MPa (for example, 100-400 MPa)) polymerization. LDPE resins typically have a density in the range of 0.915 to 0.935 g/cm³.

Two different high pressure free-radical initiated polymerization process types are known. In the first type, an agitated autoclave vessel having one or more reaction zones is used. The autoclave reactor normally has several injection points for initiator or monomer feeds, or both. In the second type, a jacketed tube is used as a tubular reactor, which has one or more reaction zones. Suitable, but not limiting, reactor lengths may be from 100 to 3000 meters (m), or from 1000 to 2000 m. The beginning of a reaction zone for the reactor is typically defined by the side injection of either initiator of the reaction, ethylene, chain transfer agent (or telomer), comonomer(s), as well as any combination thereof. A high pressure process can also be carried out in autoclave or tubular reactors having one or more reaction zones, or in a combination of autoclave and tubular reactors, each comprising one or more reaction zones.

A chain transfer agent can be used to control molecular weight. In a preferred embodiment, one or more chain transfer agents (CTAs) may be added to a polymerization process. Typical CTAs include, but are not limited to, propylene, isobutane, n-butane, 1-butene, methyl ethyl ketone, acetone, and propionaldehyde.

LDPE resins are used in many conventional thermoplastic fabrication processes to produce useful articles, including monolayer and multilayer films; molded articles, such as blow molded, injection molded, cast molded, or rotomolded articles; coatings; fibers; and woven or non-woven fabrics. The films include extrusion coatings, food packaging, consumer, industrial, agricultural (applications or films), lamination films, fresh cut produce films, cast films, blown films, thermoformed films, meat films, cheese films, candy films, clarity shrink films, collation shrink films, stretch films, silage films, greenhouse films, fumigation films, liner films, stretch hood, heavy duty shipping sacks, pet food, sandwich bags, sealants, and diaper backsheets.

LDPE resins may also be used in wire and cable coating operations, in sheet extrusion for vacuum forming operations, and forming molded articles, including the use of injection molding, blow molding, or rotomolding processes, in soft touch goods, such as appliance handles, in gaskets and profiles, in auto interior parts and profiles, in foam goods (both open and closed cell) and as impact modifiers for other thermoplastic polymers, such as high density polyethylene.

LDPE resins that are used in these applications desirably have high melt strength, high shear thinning and relatively low melt index in order to provide good processability. Especially in blends, LDPE typically adds flexibility and processability to the blend, while HDPE or LLDPE adds rigidity and strength.

For example, blown film production lines are typically limited in output by bubble stability. Blending LDPE with linear low density polyethylene (LLDPE) increases bubble stability, in part due to the higher melt strength of the LDPE. An LDPE resin that has higher melt strength can be used in smaller quantities in the extruded blend and/or can allow faster film production. However, too high of a melt strength can cause gels and poor quality film. Furthermore, some high melt-strength LDPE resins frequently have low melt index and little shear thinning, which makes them harder to process. Thus, there is a need for new ethylene-based polymers, such as LDPEs, that have an optimized balance of melt strength, melt index and rheological properties.

Many post-treatment methods are known to induce cross-linking or formation of long-chain branches in polyethylenes (HDPE, LLDPE and LDPE). Examples of known post-treatment techniques include treatment with oxygen, free-radical initiators, high-energy electromagnetic radiation and electron beams. Examples of post-treatment technology are described in the following US patents and patent applications: U.S. Pat. Nos. 4,586,995; 7,094,472 B2; U.S. Pat. No. 7,892,446 B2; U.S. Pat. No. 10,844,210 B2; US 2014/0342141A1; US 2019/0100644A1; and in the following PCT Publication: WO 2010/009024A2 and in the paper: Ono et al., Gamma Irradiation Effects in Low Density Polyethylene, 2011 International Nuclear Atlantic Conference (Oct. 24-28, 2011). In the case of LDPE resins, post-treatment research has focused more on cross-linking than long chain branching, because LDPE resins are already highly long chain branched. It is desirable to identify specific resins and treatment options that can provide improved properties for the intended use of the resins.

### SUMMARY

We have discovered that irradiation of low-density polyethylene (LDPE) resins with an electron beam produces modified polyethylene resins that have significantly improved melt strength and retain a useful melt-index with good processability and have few cross-linked gels, if the starting LDPE resin and the level of irradiation are properly selected.

One embodiment of the present invention is a process to modify an LDPE resin, which process comprises the steps of:
a. Providing a starting LDPE resin having:
   i. A density from 0.91 g/cm³ to 0.94 g/cm³;
   ii. A melt-index (I₂) from 5 to 18 dg/min; and
   iii. A conventional molecular-weight distribution (M_{w (Conv)}/M_{n (Conv)}) of at least 6; and
b. Irradiating the starting polyethylene resin with an electron-beam to provide a dosage effective to provide a modified polyethylene resin having:
   i. A melt-index (I₂) at least 1 dg/min; and
   ii. A conventional molecular weight distribution (M_{w (Conv)}/M_{n (Conv)}) of at least 10; and
   iii. A melt strength of at least 15 cN; and
   iv. A GPC mass recovery of at least 95%.

A second embodiment of the present invention is an LDPE resin having the following properties:
a. A density from 0.91 g/cm³ to 0.94 g/cm³;
b. A melt-index (12) from 1.5 dg/min to 6 dg/min; and
c. A conventional molecular weight distribution (M_{w (Conv)}/M_{n (Conv)}) from 10 to 20; and
d. A melt strength of at least 25 cN; and
e. A GPC mass recovery of at least 95%.

A third embodiment of the present invention is a manufactured article comprising the modified polyethylene formulation.

This application describes several characteristics of the starting LDPE resins and modified LDPE resins, such as density, melt index, conventional and absolute molecular weights, and various branching and rheology measurements. In each case, the characteristics described are measured by the test methods listed in the “Test Methods” section of this application. Reference to a measured characteristic should be taken as meaning the characteristic as measured by the listed test method. Alternative test methods may sometimes yield different results.

### DETAILED DESCRIPTION

In the process of this invention a starting LDPE resin is subjected to electron beam radiation.

The starting LDPE resin and the modified LDPE resin in this invention are polyethylene polymers. The term “polymer,” as used herein, refers to a polymeric compound prepared by polymerizing monomers, whether of the same or a different type. The generic term polymer thus embraces both homopolymers and interpolymers as defined hereinafter. Polyethylene homopolymers contain repeating units derived almost exclusively from ethylene, with the understanding that low amounts of impurities such as chain transfer agents can be incorporated into the polymer structure. The impurities preferably make up less than 1 weight percent of the homopolymer, more preferably less than 0.5 weight percent and most preferably less than 0.3 weight percent. Polyethylene interpolymers are polymers prepared by the polymerization of ethylene monomer with at least one different type of monomer. The generic term interpolymer includes ethylene copolymers (employed to refer to polymers prepared from ethylene and one other comonomer), and polymers prepared from ethylene and two or more comonomers. Polyethylene interpolymers may also contain low amounts of impurities such as chain transfer agents which can be incorporated into the polymer structure. In polyethylene interpolymers for this invention, preferably at least 50 weight percent of repeating units are derived from ethylene monomer. The starting LDPE resins and modified LDPE resins are more preferably ethylene homopolymers.

### Starting LDPE Resin

The starting LDPE resin has the following characteristics: (i) a density from 0.91 g/cm³ to 0.94 g/cm³; (ii) a melt-index (I₂) from 5 to 18 dg/min; and (iii) a conventional molecular weight distribution (M_{w (Conv)}/M_{n (Conv)}) of at least 6.

The density of the starting LDPE resin is from 0.91 g/cm³ to 0.94 g/cm³. The density of the starting LDPE resin is preferably at least 0.912 g/cm³, more preferably at least 0.915 g/cm³ and most preferably at least 0.917 g/cm³. The density of the starting LDPE resin is preferably at most 0.935 g/cm³, more preferably at most 0.930 g/cm³ and most preferably at most 0.925 g/cm³.

The melt index (I₂) of the starting LDPE resin component ranges from 5 dg/min to 18 dg/min. The melt index is preferably at least 6 dg/min, more preferably at least 6.5 dg/min and most preferably at least 7 dg/min. The melt index is preferably at most 17.5 dg/min and more preferably at most 17 dg/min.

The molecular weight of LDPE resins can be measured by two different methods: (1) the “conventional” or “relative” GPC method; and (2) the “absolute” method. The absolute method typically yields greater molecular weights than the conventional method for polymers with high levels of long-chain branching, such as LDPE resins.

The conventional number average molecular weight (M_{n (conv)}) of the starting LDPE resin is preferably at least 7,000 g/mol, more preferably at least 12,000 g/mol and most preferably at least 13,000 g/mol. The conventional number average molecular weight (M_{n (conv)}) of the starting LDPE resin is preferably at most 30,000 g/mol, more preferably at most 25,000 g/mol, more highly preferably at most 18,000 g/mol and most preferably at most 16,000 g/mol.

The conventional weight average molecular weight (M_{w (conv)}) of the starting LDPE resin is preferably at least 35,000 g/mol, more preferably at least 45,000 g/mol and most preferably at least 100,000 g/mol. The conventional weight average molecular weight (M_{w (conv)}) of the starting LDPE resin is preferably at most 300,000 g/mol and more preferably at most 180,000 g/mol.

The starting LDPE resin has a conventional molecular weight distribution (M_{w (conv)}/M_{n (conv)}) of at least 6. The conventional molecular weight distribution of the starting LDPE resin is preferably at least 7, more preferably at least 7.5 and most preferably at least 8. The conventional molecular weight distribution of the starting LDPE resin is preferably at most 13, more preferably at most 12 and most preferably at most 11.

The absolute weight average molecular weight (M_{w (Abs)}) of the starting LDPE resin is preferably at least 100,000 g/mol and more preferably at least 270,000 g/mol. The absolute weight average molecular weight (M_{w (Abs)})) of the starting LDPE resin is preferably at most 750,000 g/mol, more preferably at most 500,000 g/mol and most preferably at most 450,000 g/mol.

For the starting LDPE resin, the ratio of absolute molecular weight to conventional molecular weight (M_{w (Abs)}/M_{w (Conv)}) for the starting LDPE resin is preferably at least 1.5, more preferably at least 2.0 and most preferably at least 2.2. The ratio of absolute molecular weight to conventional molecular weight (M_{w (Abs)}/M_{w (Conv)}) for the starting LDPE resin is preferably at most 5, more preferably at most 3.5 and most preferably at most 2.8.

Long chain branching in polymers is also characterized by several different measurements. The measurements for branching that are described in the test methods below include: the branching index (g′), the long chain branching frequency (LCBf) and the GPC branching index (gpcBR).

The long chain branching frequency (LCBf) of the starting LDPE resin is preferably at least 0.5, more preferably at least 1.0, and most preferably at least 1.2. The long chain branching frequency (LCBf) of the starting LDPE resin is preferably at most 5.0, more preferably at most 3.5, and most preferably at most 3.0.

The GPC branching index (gpcBR) of the starting LDPE resin is preferably at least 0.5, more preferably at least 1.5 and most preferably at least 1.6. The GPC branching index (gpcBR) of the starting LDPE resin is preferably at most 6 and more preferably at most 4.

The melt strength of the starting LDPE resin at 190° C. is preferably at most 20 cN, more preferably at most 10 cN, and most preferably at most 8 cN. The ratio of melt strength (in cN)/melt index (in dg/min) for the starting LDPE resin is preferably at least 0.1. The ratio of melt strength (cN)/melt index (dg/min) for the starting LDPE resin is preferably at most 10, more preferably at most 5 and most preferably at most 1.

Preferably, the gel content in the starting LDPE resin has been minimized. (Gels are crosslinked polymers that are insoluble in trichlorobenzene, decahydronaphthalene, or xylene, or are highly entangled high molecular weight polymer chains that do not dissolve easily). Gel content is conveniently measured by measuring the quantity of resin recovered through gel permeation chromatography (GPC recovery) as described in the Test Methods. Higher resin recovery corresponds to lower gel content. The GPC recovery of the starting LDPE resin is preferably at least 95 percent, more preferably at least 97 percent, more highly preferably at least 99 percent and most preferably at least 99.5 percent. There is no maximum preferred GPC recovery; the GPC recovery may be essentially 100 percent.

Viscosity ratio is a ratio of the viscosity of the resin under low-shear conditions (0.1 rad/s) divided by the viscosity of the resin under high shear conditions (100 rad/s), both at a temperature of 190° C. The viscosity ratio of the starting LDPE resin is preferably at least 1, more preferably at least 4 and most preferably at least 5. The viscosity ratio of the starting LDPE resin is preferably at most 20, more preferably at most 10 and most preferably at most 9.

Tangent of the phase angle δ (tan-δ) is a viscoelastic measurement indicating the ratio of loss modulus (G″) divided by storage modulus (G′) under low shear conditions (0.1 rad/s) at a temperature of 190° C. The starting LDPE resin preferably has a tan-δ at 0.1 rad/s of at least 3, more preferably at least 5 and most preferably at least 6. The tan-δ of the starting LDPE resin is preferably at most 50, more preferably at most 10, and most preferably at most 8.

The starting LDPE resin may be a single polymer or a blend of two or more polymers. If it is a blend, the preferred embodiments above apply to the individual polymer components. Preferably, the starting LDPE resin is a single polymer. The starting LDPE resin may optionally contain common additives, such as antistatic agents, color enhancers, dyes, lubricants, fillers, pigments, primary antioxidants, secondary antioxidants, processing aids, UV stabilizers, nucleators, slip agents such as erucamide, antiblock agents such as talc, and combinations thereof. Preferably, additives in the starting LDPE resin do not interfere with long chain branch formation. More preferably, the starting LDPE resin contains essentially no additives.

Starting LDPE resins are commercially available or can be made by known processes as described above in the Background Section. Starting LDPE resins are preferably made by free radical polymerization of ethylene monomer and optionally comonomers at a temperature of 180° C. to 350° C. and a pressure of from 14,500 psi to 58,000 psi (100-400 MPa). Polymerization is initiated by common free-radical initiators, such as organic peroxide initiators. Chain length can be controlled by adding chain transfer agents, such as butane, isobutane, butene, propylene, propionaldehyde, or methyl ethyl ketone. The reactor system may contain one or more autoclaves or high-pressure tubular reactors. However, starting LDPE resins in this invention have molecular weight distributions at the broader end of the range that is common for LDPE resins, and LDPE resins with broad molecular weight distribution are more commonly made in autoclave reactors. If a tubular reactor system is used, conditions should be adapted to produce the desired molecular weight distribution.

The starting LDPE resin is preferably a powder, granule or pellet and is more preferably a pellet. Pellets generally have 10-60 pellets per gram.

### Electron Bean Modification

In the process of this invention, the starting LDPE resin is modified by irradiation with an electron beam. Without being bound, we theorize that when the e-beam enters a polymer it ionizes and excites the molecules resulting in the displacement of hydrogen atoms and formation of free radicals. The combination of two free radicals forms long-chain branches. The additional long chain branches increase melt strength. We further theorize that the dosage of radiation should be high enough to initiate long chain branching, but low enough to avoid formation of highly cross-linked networks, which are gels.

Sources for electron beam radiation are known and commercially available. The electron beam is preferably emitted from a linear electron beam accelerator. Generally, an electron beam is emitted from a heated cathode filament (typically tungsten). In a linear accelerator, the electrons emitted from the cathode are accelerated in an electric field applied between a cathode and an anode. The energy gain of the electron beam is proportional to the acceleration voltage. The energy is measured in eV (electron-volts), and accelerators up to 12 MeV are commercially available. The dosage of e-beam absorbed by a substance is measured in megarad (MRad, 1 Rad=0.01 Gy=0.01 J/kg).

The level of irradiation should be selected to achieve the following results:
i. A melt-index (I₂) of at least 1 dg/min; and
ii. A conventional molecular weight distribution (M_{w (Conv)}/M_{n (Conv)}) of at least 10; and
iii. A melt strength of at least 20 cN; and
iv. GPC mass recovery of 95% or greater

The starting LDPE resin preferably receives an average dosage of at least 0.2 MRad, more preferably at least 0.25 MRad, more highly preferably at least 0.4 MRad, and most preferably at least 0.45 MRad. The starting LDPE resin preferably receives an average dosage of at most 1.25 MRad, more preferably at most 1 MRad, and most preferably at most 0.8 MRad.

Generally, if the irradiation is too low, the desired melt-strength cannot be achieved in the modified LDPE resin. If the irradiation is too high, the melt index of the modified LDPE resin is too low, and the GPC recovery is too low.

To achieve the desired level of irradiation, the linear electron beam accelerator preferably has the following characteristics.
The linear electron beam accelerator preferably operates at a beam energy range of at least 2 MeV, more preferably at least 3 MeV and most preferably at least 4 MeV. The linear electron beam accelerator preferably operates at an energy range of at most 12 MeV, more preferably at most 8 MeV and most preferably at most 5 MeV.
The electron beam power depends on the beam energy and the beam current. The electron beam power over the whole energy range is preferably at least 20 kW, more preferably at least 30 kW and most preferably at least 75 kW. The electron beam power over the whole energy range is preferably at most 350 kW, more preferably at most 200 kW and most preferably at most 175 kW.

The electron beam penetration depth of the starting LDPE resin during irradiation is preferably shallow enough to allow all of the starting LDPE resin to receive a uniform desired dosage of electron beam radiation. Without being bound to any theory, the penetration depth of the electron beam depends upon the density of the LDPE and the beam energy (MeV). For example, a 4.5 MeV beam is preferably used to irradiate the starting LDPE resin to a penetration depth of at most 6 cm, more preferably at most 4.5 cm and most preferably at most 3.5 cm, to ensure that all of the starting LDPE resin receives adequate and uniform exposure to the radiation.

Irradiation preferably takes place in vacuum, air or inert atmosphere. Irradiation more preferably takes place in air. The e-beaming may be performed in a batch or continuous process. A continuous process where the starting LDPE resin is conveyed on a belt and exposed to an E-beam curtain is preferred.

The preferred time of irradiation depends on the strength of the electron beam source (beam energy, current and beam power). Persons of ordinary skill can readily determine by experimentation the optimum time for irradiation based on the polymers and equipment they are working with.

Hypothetically, similar results can be obtained by irradiation at the same level of dosage with higher energy electromagnetic radiation, such as x-rays or gamma rays. However, the process was not investigated due to practical difficulties in obtaining a suitable source.

### Modified LDPE Resin

The product of the irradiation is a modified LDPE resin. The irradiation process does not materially change the following characteristics of the starting LDPE resin, and so the limits and preferred embodiments of the following characteristics of the modified LDPE resin after irradiation are the same as the limits and preferred embodiments for the starting PE resin: density, monomer and comonomer content, single polymer or blend of polymers, additive content, and physical form (powder, granule or pellet).

The melt index (12) of the modified LDPE resin is preferably at least 1.0 dg/min, more preferably at least 1.5 dg/min, and most preferably at least 2 dg/min. The melt index of the modified LDPE resin is preferably at most 10 dg/min, more preferably at most 6 dg/min, and most preferably at most 3 dg/min.

The melt index (12) of the modified LDPE resin is preferably at least 10% of the melt index of the starting LDPE resin and more preferably at least 20%. The melt index (I₂) of the modified LDPE resin is preferably at most 60% of the melt index of the starting LDPE resin and more preferably at most 30% of the melt index of the starting LDPE resin.

The conventional number average molecular weight (M_{n (conv)}) of the modified LDPE resin is preferably at least 7,000 g/mol, more preferably at least 9,000 g/mol, and most preferably at least 13,000 g/mol. The conventional number average molecular weight (M_{n (Conv)}) of the modified LDPE resin is preferably at most 30,000 g/mol, more preferably at most 19,000 g/mol and most preferably at most 15,500 g/mol.

The conventional weight average molecular weight (M_{w (conv)}) of the modified LDPE resin is preferably at least 45,000 g/mol, more preferably at least 100,000 g/mol and most preferably at least 120,000 g/mol. The conventional weight average molecular weight of the modified LDPE resin is preferably at most 400,000 g/mol, more preferably at most 300,000 g/mol and most preferably at most 265,000 g/mol.

The conventional molecular weight distribution (M_{w (Conv)}/M_{n (Conv)}) of the modified LDPE resin is at least 10. The conventional molecular weight distribution of the modified LDPE resin is preferably at least 12 and more preferably at least 14. The conventional molecular weight distribution of the modified LDPE resin is preferably at most 25, more preferably at most 20, and most preferably at most 18.

The absolute weight average molecular weight (M_{w (Abs)}) of the modified LDPE resin is preferably at least 100,000 g/mol, more preferably at least 200,000 g/mol and most preferably at least 350,000 g/mol. The absolute weight average molecular weight of the modified LDPE resin is preferably at most 2,500,000 g/mol, more preferably at most 1,700,000 g/mol, and most preferably at most 1,250,000 g/mol.

For the modified LDPE resin, the ratio of the absolute weight average molecular weight to the conventional weight average molecular weight (M_{w (Abs)})/(M_{w (Conv)}) is preferably at least 1.6, more preferably at least 1.8 and most preferably at least 3.5. For the modified LDPE resin, the ratio of the absolute weight average molecular weight to the conventional weight average molecular weight (M_{w (Abs)})/(M_{w (Conv)}) is preferably at most 12, more preferably at most 8, and most preferably at most 5.

The long chain branching frequency (LCBf) of the modified LDPE resin is preferably at least 0.6, more preferably at least 1.0, more highly preferably at least 3.5, and most preferably at least 5. The long chain branching frequency (LCBf) of the modified LDPE resin is preferably at most 10, more preferably at most 8.0, and most preferably at most 7.6.

A preferred goal of the modification process is to increase long chain branching in the starting LDPE resin. The long chain branching frequency (LCBf) of the modified LDPE resin is preferably at least 20% percent higher, as compared to the starting LDPE resin, more preferably at least 50% percent higher, and most preferably at least 100% higher. The long chain branching frequency (LCBf) of the modified LDPE resin is preferably at most 300% higher, as compared to the starting LDPE resin.

The GPC branching index (gpcBR) of the modified LDPE resin is preferably at least 0.6, more preferably at least 0.8, more highly preferably at least 2.0 and most preferably at least 3.5. The GPC branching index (gpcBR) of the modified LDPE resin is preferably at most 12, more preferably at most 10 and most preferably at most 8.

The modified LDPE resin preferably has a melt strength at 190° C. of at least 15 cN, more preferably at least 20 cN and most preferably at least 25 cN. The melt strength is preferably at most 35 cN and more preferably at most 32 cN.

One goal of the modification process is to increase the melt strength of the starting LDPE resin. The melt strength at 190° C. of the modified LDPE resin is preferably at least 10 cN higher than the melt strength of the starting LDPE resin, more preferably at least 15 cN higher, more preferably at least 20 cN higher and most preferably at least 25 cN higher. The melt strength of the modified LDPE resin is preferably at most 45 cN higher than the melt strength of the starting LDPE resin, more preferably at most 35 cN higher and most preferably at most 30 cN higher. Usually, tubular reactor systems can produce LDPE resins at higher capacity and ethylene conversion rates, but LDPE resins made in an autoclave reactor system have higher melt strength. In one embodiment of the invention, the starting LDPE resin is a product of a tubular reactor system; the modification process can nevertheless give it melt strength similar to or even superior to conventional LDPE resins made in an autoclave reactor system.

The modified LDPE resin preferably has a viscosity ratio at 190° C. of at least 5, more preferably at least 9 and most preferably at least 12. The viscosity ratio is preferably at most 30, more preferably at most 25, and most preferably at most 18. The viscosity ratio of the modified LDPE resin is preferably at least 10% higher than the starting LDPE resin, more preferably at least 20% higher and most preferably at least 25% higher. The change in viscosity ratio indicates that the modified LDPE resin can form a more stable film at higher throughput rates in blown film production.

The modified LDPE resin preferably has a tan-δ at 190° C. and 0.1 rad/s of at least 1 and more preferably at least 2. The tan-δ is preferably at most 10, more preferably at most 5, and most preferably at most 3. The tan-δ of the modified LDPE resin is preferably at most 65 percent of the tan-δ of the starting LDPE resin and more preferably at most 50 percent. The lower tan-δ of the modified LDPE resins shows that they have improved elasticity.

The ratio of melt strength (in cN)/melt index (in dg/min) for the modified LDPE resin is preferably at least 1, more preferably at least 3 and most preferably at least 10. The ratio of melt strength (cN)/melt index (dg/min) for the modified LDPE resin is preferably at most 30 and more preferably at most 20.

One goal of the modification process is to limit the formation of gels in the modified LDPE resin. The gel content of the modified LDPE resin is preferably less than 3 weight percent, more preferably less than 2.8 weight percent, more highly preferably less than 2 weight percent and most preferably less than 1 weight percent. In many cases, the gel content of the modified LDPE resin can be essentially 0 weight percent; the measured gel content can be less than or equal to the usual confidence limits of the test.

The GPC recovery of the modified LDPE resin is preferably at least 95 percent, based on the weight of the modified LDPE resin, more preferably essentially 100 percent. For clarity, the electron beam modification is not expected to reduce gel content, but the conditions of the modification are preferably selected to avoid or minimize formation of additional gels.

One example of a preferred modified LDPE resin has the following properties:
a. A density from 0.91 g/cm³ to 0.94 g/cm³;
b. A melt-index (I₂) from 1.5 dg/min to 6 dg/min; and
c. A conventional molecular weight distribution (M_{w (Conv)}/M_{n (Conv)}) from 10 to 20; and
d. A melt strength of at least 25 cN; and
e. a GPC mass recovery of 95% or greater.

If the modified polyethylene resin was irradiated as a powder or granule, then it is preferably extruded to form a pellet. The pellet may optionally include additives, such as antistatic agents, color enhancers, dyes, lubricants, fillers, pigments, primary antioxidants, secondary antioxidants, processing aids, UV stabilizers, nucleators, slip agents such as erucamide, antiblock agents such as talc, and combinations thereof; preferably, it does not include material quantities of additives.

The powder, granule or pellets may be blended and/or coextruded with other resins, such as HDPE, LLDPE, or another LDPE, to make resin blends. It is well known to select and blend polyethylene resins having selected properties, so that the overall blend has desired properties.

The powder, granule pellets or blends may be extruded to make extruded single layer or multilayer films and sheets, extruded coatings and extruded blow-molded articles and other products. This technology is well known and described briefly in the Background. Preferred uses for the modified LDPE resins and blends that contain them include blown and cast single layer and multi-layer films, stretched single layer and multi-layer films and extruded single-layer and multi-layer coatings.

### Test Methods

Throughout this description and the attached claims, references to the physical and chemical properties of the LDPE resin mean the properties as they are measured by the following test methods.

Density: Density is measured according to ASTM D792, Method B.

Melt Index: Melt index, or I₂, is measured according to ASTM D1238 at 190° C., 2.16 kg. Results are reported in decigrams per minute (dg/min).

Melt Strength: Melt strength is measured at 190° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets are fed into the barrel (L=300 mm, Diameter=12 mm), compressed and allowed to melt for 10 minutes before being extruded at a constant piston speed of 0.265 mm/s, which corresponds to a wall shear rate of 38.2 s⁻¹ at the given die diameter. The extrudate passes through the wheels of the Rheotens located at 100 mm below the die exit and is pulled by the wheels downward at an acceleration rate of 2.4 mm/s². The force (in cN) exerted on the wheels is recorded as a function of the velocity of the wheels (mm/s). Melt strength is reported as the plateau force (cN) before the strand breaks or has significant draw resonance.

Irradiation Level: The e-beam is calibrated using dosimetry films and measuring change in color. The irradiation level can then be calculated based on the electron beam energy, current and the belt speed.

Gel Content. The gel content (insoluble fraction) produced by cross linking is determined by extracting with the solvent decahydronaphthalene. It is applicable to cross-linked ethylene plastics of all densities, including those containing fillers, and all provide corrections for the inert fillers present in some of those compounds. See ASTM D2765-16, Standard Test Methods for Determination of Gel Content and Swell Ratio of Crosslinked Ethylene Plastics, ASTM International, West Conshohocken, PA, 2016, www.astm.org.

Vinyl Content: The vinyl content of LDPE is determined by 1H NMR spectroscopic methods, which are described in Busico, V., et al., Macromolecules, 2005, 38, 6988 and U.S. Pat. No. 8,916,667 from col 11, line 35 to col. 12, line 15.

Samples were prepared by adding ˜0.1 to 0.2 g of sample to 3.25 g of 50/50 by weight 1,1,2,2-tetrachlorethane-d2/perchloroethylene (TCE/PCE) containing 0.001 M Cr(AcAc)₃ and about 75 ppm butylated hydroxytoluene (BHT), in a Norell 1001-7 10 mm NMR tube. The samples were purged by bubbling N₂ through the solvent via a pipette inserted into the tube for approximately 3 minutes to remove oxygen, capped, sealed with Teflon tape and then heated and vortexed at 115° C. to dissolve and ensure homogeneity.

1H NMR was performed on a Bruker AVANCE 600 MHz spectrometer equipped with a Bruker high-temperature CryoProbe at a sample temperature of 120° C. Spectra were acquired with ZG pulse, 1.8 s AQ, 64 or 128 scans with a relaxation delay of 14 s.

The spectra were referenced to the residual proton signal of TCE at 6.0 ppm. The total polymer integral from about −0.5 to 2.5 ppm was set to an arbitrary value, for example, 2000. The corresponding integrals for unsaturations (cis- and trans-vinylenes from about 5.40 to 5.60 ppm, trisubstituted from about 5.16 to 5.35 ppm, vinyl from about 5.0 to 5.15 ppm, and vinylidene from about 4.75 to 4.85 ppm) were obtained. The BHT —OH signal at about 4.9 ppm was not included in the integral areas.

The integral of the whole polymer is divided by 2 to obtain the total polymer carbons, 1000 in this example. The unsaturated group integrals divided by the corresponding number of protons contributing to that integral represent the moles of each type of unsaturation per 1000 moles of total polymer carbons. This is referred to as unsaturated groups per 1000 carbons.

### Nuclear Magnetic Resonance (13C NMR for Branching)

Samples for 13C NMR were prepared by adding approximately 3 g of 1,1,2,2-tetrachloroethane (TCE) containing 25 wt % TCE-d2 and 0.025 M Cr(AcAc)₃, to about 0.25 g polymer sample, in a 10 mm NMR tube. Oxygen was removed from the sample by purging the headspace with nitrogen. The samples were then dissolved and homogenized by heating the tube and its contents to 120-140° C. using a heating block and vortex mixer. Each dissolved sample was visually inspected to ensure homogeneity. Samples were thoroughly mixed immediately prior to analysis and were not allowed to cool before insertion into the heated NMR sample holders.

All data were collected using a Bruker 600 MHz spectrometer equipped with a 10 mm high temperature cryoprobe. The 13C data was acquired using a 7.8 second pulse repetition delay, 90-degree flip angles, and inverse gated decoupling, with a sample temperature of 120° C. All measurements were made on non-spinning samples in locked mode. Samples were allowed to thermally equilibrate for seven minutes prior to data acquisition. The 13C NMR chemical shifts were internally referenced to the EEE triad at 30.0 ppm. Table 1 lists the peak assignments used for branching measurement in LDPE. The “C6+” value is a direct measure of C6+ branches in LDPE, where the long branches are not distinguished from “chain ends.” The “32.2 ppm” peak, representing the third carbon from the end of all chains or branches of six or more carbons, is used to determine the “C6+” value.

TABLE 1
Branching Type and 13C NMR integral ranges used for quantitation

| Branch Type | Peak(s) integrated | Identity of the integrated carbon peak(s) |
|---|---|---|
| 1,3 diethyl | about 10.5 to 11.5 ppm | 1,3 diethyl branch methyls |
| C2 on quaternary | about 7.5 to 8.5 ppm | 2 ethyl branches on a quaternary carbon, |
| carbon | | methyls |
| C4 | about 23.3 to 23.5 ppm | Second CH₂ in a 4-carbon branch, counting |
| | | the methyl as the first C |
| C5 | about 32.60 to 32.80 ppm | Third CH₂ in a 5-carbon branch, counting |
| | | the methyl as the first C |
| C6+ | about 32.1 to 32.3 ppm | The third CH₂ (counting the methyl as the |
| | | first C) in any branch of 6 or more carbons |
| | | in length |
| C4+ | about 38.2 ppm | The CH carbon for branches or segments of |
| | | 4 or more carbons in length, when said |
| | | branch is at least about 4 to 5 carbons distant |
| | | from any other branch |

Gel Permeation Chromatography (GPC) for Measurement of Conventional Molecular Weight (Mw_{conv}), Absolute Molecular Weight (Mw_{Abs}), Long Chain Branching Frequency (LCB_{f}), and gpcBR.

The chromatographic system consists of a PolymerChar GPC-IR (Valencia, Spain) high temperature GPC chromatograph equipped with an internal IR5 infra-red detector (IR5), a Precision Detectors (Now Agilent Technologies) 2-angle laser light scattering (LS) detector Model 2040, and an internal 4-capillary viscometer. For all light scattering measurements, the 15 degree angle is used.

The Systematic Approach for the determination of multi-detector offsets was done in a manner consistent with that published by Balke, Mourey, et. al., optimizing triple detector log (MW and IV) results from a broad homopolymer polyethylene standard (M_{w}/Mₙ>2.7) to the narrow standard column calibration results from the narrow standards calibration curve using PolymerChar GPCOne™ Software. As used herein, “MW” refers to molecular weight and MWD refers to molecular weight distribution.

Columns and Calibration: The columns in the GPC chromatograph are four Agilent “Mixed A” 30 cm 20-micron linear mixed-bed columns and a 20-um pre-column. The autosampler oven compartment is at 160° Celsius and the column compartment was set at 150° Celsius.

Calibration of the GPC column set is performed with 21 narrow molecular weight distribution polystyrene standards with molecular weights ranging from 580 g/mol to 8,400,000 g/mol and were arranged in 6 “cocktail” mixtures with at least a decade of separation between individual molecular weights. The standards are purchased from Agilent Technologies. The polystyrene standards are prepared at 0.025 grams in 50 milliliters of solvent for molecular weights equal to or at least 1,000,000 g/mol, and 0.05 grams in 50 milliliters of solvent for molecular weights less than 1,000,000 g/mol. The polystyrene standards are dissolved at 80 degrees Celsius with gentle agitation for 30 minutes. The polystyrene standard peak molecular weights are converted to polyethylene molecular weights using Equation 1 (as described in Williams and Ward, J. Polym. Sci., Polym. Let., 6, 621 (1968)):

MW_{polyethylene}=A×(Mw_{polystyrene})^{B} (1)

where MW is the molecular weight, A has a value of 0.4315 and B is equal to 1.0.

A fifth order polynomial is used to fit the respective polyethylene-equivalent calibration points. (A small adjustment to A (from approximately 0.3950 to 0.440) was made to correct for column resolution and band-broadening effects such that such that linear homopolymer polyethylene standard is obtained at 120,000 Mw).

The total plate count of the GPC column set is performed with decane (prepared at 0.04 g in 50 milliliters of TCB.) The plate count (Equation 2) and symmetry (Equation 3) are measured on a 200 microliter injection according to the following equations:

$$\\ \begin{matrix}Plate Count = 5.54 * {( \frac{{RV}_{Peak Max}}{Peak Width at \frac{1}{2} height} )}^{2} & ( 2 )\end{matrix}$$

where RV is the retention volume in milliliters, the peak width is in milliliters, the peak max is the maximum height of the peak, and ½ height is ½ height of the peak maximum;
   and

$$\\ \begin{matrix}Symmetry = \frac{( Rear Peak {RV}_{one tenth height} - {RV}_{Peak max} )}{( {RV}_{Peak max} - Front Peak {RV}_{one tenth height} )} & ( 3 )\end{matrix}$$

where RV is the retention volume in milliliters and the peak width is in milliliters, Peak max is the maximum position of the peak, one tenth height is 1/10 height of the peak maximum, rear peak refers to the peak tail at later retention volumes than the peak max, and front peak refers to the peak front at earlier retention volumes than the peak max.
   The plate count for the chromatographic system should be at least 20,000 and symmetry should be between 0.98 and 1.22.

LDPE Sample Preparation and Separation: LDPE Samples are prepared as follows: The chromatographic solvent is 1,2,4 trichlorobenzene containing 200 ppm of butylated hydroxytoluene (BHT). The solvent source is nitrogen sparged. Samples are prepared in a semi-automatic manner with the PolymerChar “Instrument Control” Software, wherein the samples are weight-targeted at 1 mg/ml, and the solvent is added to a pre nitrogen-sparged septum-capped vial, via the PolymerChar high temperature autosampler. The samples are dissolved for 2 hours at 160° Celsius under low orbital shaking. The injection volume into the columns is 200 microliters, and the flow rate was 1.0 milliliters/min.

In order to monitor flow rate deviations over time, a flowrate marker (decane) is introduced into each sample via a micropump controlled with the PolymerChar GPC-IR system. This flowrate marker (FM) is used to linearly correct the pump flowrate (Flowrate(nominal)) for each sample by retention volume (RV) alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 4. The flow marker peak is processed via the PolymerChar GPCOne™ Software. Acceptable flowrate correction is such that the effective flowrate should be within +/−1% of the nominal flowrate.

Flowrate(effective)=Flowrate(nominal)*(RV(FM Calibrated)/RV(FM Sample)) (4)

### Analysis of Data

Conventional Molecular Weight and GPC recovery are calculated from internal IR5 detector (measurement channel) data.

The Mn (conv) and Mw (conv) are calculated according to Equations 5-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$$\\ \begin{matrix}Mn ( conv ) = \frac{{\sum }^{i} {IR}_{i}}{{\sum }^{i} ( {IR}_{i} / {M}_{polyet {hylene}_{i}} )} & ( 5 )\end{matrix}$$

$$\\ \begin{matrix}Mw ( conv ) = \frac{{\sum }^{i} ( {IR}_{i} * {M}_{polyet {hylene}_{i}} )}{{\sum }^{i} {IR}_{i}} & ( 6 )\end{matrix}$$

GPC recovery was determined in a way consistent with that used within PolymerChar GPCOne Software using the total signal areas of a sample eluted by the GPC method via IR5 broad filter detector and adjusted using a mass constant as determined with a vendor recommended polyethylene homopolymer standard. Mass recovery is calculated by the expression M-REC=100×[(initial analyte−filtered analyte)/initial analyte] using the analyte mass values obtained in the PolymerChar SoGPC test. It is understood that polymers with internal crosslinking form insoluble gels that are quantifiably detectable by low mass recovery analysis.

The absolute (abs) molecular weight data is obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software.

The absolute weight average molecular weight (M_{w(Abs)}) is obtained (using GPCOne™) from the area of the Light Scattering (LS) integrated chromatogram (factored by the light scattering constant) divided by the mass recovered from the mass constant and the mass detector (IR5) area at each elution volume. The overall injected concentration, used in the determination of the molecular weight, is obtained from the mass detector area and the mass detector constant, derived from a suitable linear polyethylene homopolymer, or one of the polyethylene standards of known weight-average molecular weight. The mass detector response (IR5) and the light scattering constant (determined using GPCOne™) is determined from a linear polyethylene standard with a molecular weight in excess of about 50,000 g/mole. The calculated molecular weights (using GPCOne™) were obtained using a light scattering constant, derived from one or more of the polyethylene standards mentioned below, and a refractive index concentration coefficient, dn/dc, of 0.104.

Generally, the viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity (IV). The chromatographic concentrations are assumed low enough to eliminate addressing 2^{nd} viral coefficient effects (concentration effects on molecular weight). The absolute weight average molecular weight (M_{w}(Abs)) is obtained (using GPCOne™) from the area of the Light Scattering (LS) integrated chromatogram (factored by the light scattering constant) divided by the mass recovered from the mass constant and the mass detector (IR5) area at each elution volume. The molecular weight and intrinsic viscosity responses are extrapolated at chromatographic ends where signal to noise becomes low (using GPCOne™).

The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity (IV).

### Calculation of Comparative Branching (gpcBR)

The gpcBR branching index method for the characterization of long chain branching is described in Yau, Wallace W., “Examples of Using 3D-GPC-TREF for Polyolefin Characterization,” Macromol. Symp., 2007, 257, 29-45.

The gpcBR branching index is determined using data from the light scattering, viscosity, and concentration detectors as described previously. Baselines are subtracted from the light scattering, viscometer, and concentration chromatograms. Integration windows are set to ensure integration of all of the low molecular weight retention volume range in the light scattering and viscometer chromatograms that indicate the presence of detectable polymer from the infrared (IR5) chromatogram.

Linear polyethylene standards are used to establish polyethylene and polystyrene Mark-Houwink constants. Upon obtaining the constants, the two values are used to construct two linear reference conventional calibrations for polyethylene molecular weight and polyethylene intrinsic viscosity as a function of elution volume, as shown in Equations (7) and (8):

MW_{PE}(K_{PS}/K_{PE})^{1/αPE+1}·MW_{PS}^{αPS+1/αPE+1} (7)

[η]_{PE}=K_{PS}·MW_{PS}^{α+1}/MW_{PE} (8)

With 3D-GPC, sample intrinsic viscosities are also obtained independently using Equation (9). This area calculation offers more precision, because, as an overall sample area, it is much less sensitive to variation caused by detector noise and 3D-GPC settings on baseline and integration limits. More importantly, the peak area calculation is not affected by the detector volume offsets. Similarly, the high-precision sample intrinsic viscosity (IV) is obtained by the area method shown in Equation (9):

$$\\ \begin{matrix}{IV}_{w} = \frac{{\sum }_{i} {c}_{i} {IV}_{i}}{{\sum }_{i} {c}_{i}} = \frac{{\sum }_{i} {η}_{{sp}_{i}}}{{\sum }_{i} {c}_{i}} = \frac{Viscometer Area}{Conc . Area} & ( 9 )\end{matrix}$$

where ηₛₚᵢ stands for the specific viscosity as acquired from the viscometer detector.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

Initially, the molecular weight and intrinsic viscosity for a linear polyethylene standard sample, such as SRM1475a or an equivalent, are determined using the conventional calibrations (“cc”) for both molecular weight and intrinsic viscosity as a function of elution volume, per Equations (10) and (11):

$$\\ \begin{matrix}{[ η ]}_{cc} = \frac{{\sum }_{i} {c}_{i} {IV}_{i , cc}}{{\sum }_{i} {c}_{i}} = {\frac{{\sum }_{i} {c}_{i} K ( {M}_{i , cc} )}{{\sum }_{i} {c}_{i}}}^{a} & ( 10 )\end{matrix}$$

Equation (11) is used to determine the gpcBR branching index:

$$\\ \begin{matrix}gpcBR = [ ( \frac{{[ η ]}_{cc}}{[ η ]} ) {( \frac{{M}_{w}}{{M}_{w , cc}} )}^{{α}_{PE}} - 1 ] & ( 11 )\end{matrix}$$

Wherein: [η] is the measured intrinsic viscosity, [η]cc is the intrinsic viscosity from the conventional calibration, Mw is the measured weight average molecular weight and Mw,cc is the weight average molecular weight of the conventional calibration.
The weight average molecular weight by light scattering (LS) is commonly referred to as “absolute weight average molecular weight” or “M_{w (Abs)}.” The Mw,cc from Equation (6) using conventional GPC molecular weight calibration curve (“conventional calibration”) is often referred to as “polymer chain backbone molecular weight,” “conventional weight average molecular weight,” and “Mw (conv).”

All statistical values with the “cc” subscript are determined using their respective elution volumes, the corresponding conventional calibration as previously described, and the concentration (Ci). The non-subscripted values are measured values based on the mass detector, LALLS, and viscometer areas. The value of KPE is adjusted iteratively, until the linear reference sample has a gpcBR measured value of zero. For example, the final values for α and Log K for the determination of gpcBR in this case are 0.725 and −3.391, respectively, for polyethylene, and 0.722 and −3.993, respectively, for polystyrene. Once the K and a values have been determined using the procedure discussed previously, the procedure is repeated using the branched samples. The branched samples are analyzed using the final Mark-Houwink constants obtained from the linear reference as the best “cc” calibration values.

For linear polymers, gpcBR calculated from Equation (11) will be close to zero, since the values measured by LS and viscometry will be close to the conventional calibration standard. For branched polymers, gpcBR will be higher than zero, especially with high levels of long chain branching, because the measured polymer molecular weight will be higher than the calculated Mw,cc, and the calculated IVcc will be higher than the measured polymer IV. The gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight.

### Calculation of LCB Frequency (LCB_{f})

The LCB_{f} (_{LCB1000C)} (in long-chain branches per 1000 carbon atoms) is calculated for each polymer sample by the following procedure:
1) The light scattering, viscosity, and concentration detectors are calibrated with NBS 1475 homopolymer polyethylene (or equivalent linear reference).
2) The light scattering and viscometer detector offsets are corrected relative to the concentration detector as described above in the calibration section (see references to Mourey and Balke).
3) Baselines are subtracted from the light scattering, viscometer, and concentration chromatograms and set integration windows making certain to integrate all of the low molecular weight retention volume range in the light scattering chromatogram that is observable from the refractometer chromatogram.
4) A linear homopolymer polyethylene Mark-Houwink reference line is established by injecting a standard with a polydispersity of at least 3.0, calculate the data file (from above calibration method), and record the intrinsic viscosity and molecular weight from the mass constant corrected data for each chromatographic slice.
5) The LDPE sample of interest is analyzed, the data file (from above calibration method) is calculated, and the intrinsic viscosity and molecular weight from the mass constant, corrected data for each chromatographic slice, is recorded. At lower molecular weights, the intrinsic viscosity and the molecular weight data may need to be extrapolated such that the measured molecular weight and intrinsic viscosity asymptotically approach a linear homopolymer GPC calibration curve.
6) The homopolymer linear reference intrinsic viscosity is shifted at each point (i) by the following factor: IVi=IVi*0.946 where IV is the intrinsic viscosity.
7) The homopolymer linear reference molecular weight is shifted by the following factor: MW=MW*1.57 where MW is the molecular weight.
8) The g′ at each chromatographic slice is calculated according to the following equation:

g′=(IV(LDPE)/IV(linear reference)),
at the same MW. The IV(linear reference) was calculated from a fifth-order polynomial fit of the reference Mark-Houwink Plot and where IV(linear reference) is the intrinsic viscosity of the linear homopolymer polyethylene reference (adding an amount of SCB (short chain branching) to account for backbiting through Equations 5) and 6) at the same molecular weight (MW)). The IV ratio is assumed to be one at molecular weights less than 3,500 g/mol to account for natural scatter in the light scattering data.
9) The number of branches at each data slice was calculated according to Equation 12 (as described in Zimm, Stockmayer J. Chem. Phys. 17, 1301 (1949)):

(12)
10) The average LCB quantity was calculated across all of the slices (i), according to Equation 13:

$$\\ \begin{matrix}{LCB}_{f} = \frac{{\sum }_{M = 3500}^{i} ( \frac{{B}_{ni}}{{M}_{i} * 14000} {C}_{i} )}{\sum {C}_{i}} & ( 13 )\end{matrix}$$

### Examples

The following starting LDPE resins are obtained from commercial stocks of pelleted resin: LDPE 722, LDPE 4016, AGILITY™ EC 7080, LDPE 780E, LDPE 993I, and LDPE 9551. All resins are available from Dow, Inc. The resins are additive-free, except LDPE 993I contains slip-agent. Initial Properties of each resin are measured using the Test Methods described above, and the results are listed in Table 2.

TABLE 2

| | | | | AGILITY | | | |
|---|---|---|---|---|---|---|---|
| Resin | Units | 722 | 4016 | EC 7080 | 780E | 993I | 955I |
| Density | g/cm³ | 0.918 | 0.918 | 0.918 | 0.923 | 0.923 | 0.923 |
| Melt Index (I₂) | dg/min | 8.0 | 16 | 8.0 | 20 | 25 | 35 |
| Melt Strength | cN | 5.6 | 2.8 | 4.8 | 0.4 | 0.5 | 0.1 |
| Melt Strength/ | cN/ | 0.7 | 0.2 | 0.6 | 0.02 | 0.02 | 0.003 |
| Melt Index | (dg/min.) | | | | | | |
| Conventional Mₙ | Kg/mol | 15.7 | 14.6 | 13.1 | 12.6 | 13.8 | 17.5 |
| Conventional M_{w} | Kg/mol | 169 | 143 | 106 | 68.9 | 86.3 | 47.9 |
| M_{w (Conv)}/M_{n (Conv)} | n/a | 10.8 | 9.85 | 8.04 | 5.47 | 6.27 | 2.74 |
| Absolute Mw | Kg/mol | 471 | 397 | 276 | 151 | 178 | 101 |
| M_{w (Abs)}/M_{w (Conv)} | n/a | 2.79 | 2.77 | 2.61 | 2.20 | 2.06 | 2.12 |
| LCB_{f} | | 2.06 | 2.25 | 3.02 | 1.75 | 1.31 | 1.19 |
| Branching Index | | 0.622 | 0.623 | 0.578 | 0.644 | 0.697 | 0.722 |
| (g′) | | | | | | | |
| gpcBR | | 4.00 | 3.89 | 2.87 | 2.03 | 2.10 | 1.58 |
| Viscosity Ratio | | 8.82 | 5.11 | 8.83 | 3.55 | 3.51 | 1.67 |
| Tan-δ (0.1 rad/s) | | 7.41 | 6.78 | 7.41 | 32.5 | 32.4 | 83.1 |
| GPC Recovery | Wt % | 103 | 103 | 108 | 105 | 103 | 102 |
| Gel Content | Wt % | −0.031 | — | — | — | — | — |

Each of the resins is irradiated to the dosage listed in Table 3, using the following procedures: Modified LDPEs are produced by irradiating the starting LDPEs to a pre-determined dosage (up to 1.15 MRad) using a DYNAMITRON linear electron beam accelerator in air. The operating parameters of the electron-beam accelerator are: an energy range of 4.5 MeV, a beam power over the whole energy range of 150 kW, a beam energy spread of +/−10 percent and an average current of 30 milliamps (mA).

After irradiation, the properties of each resin are remeasured. In addition, the same properties are measured on three commercial resin samples that have not been irradiated: LDPE 621I from Dow Inc., LDPE 662I from Dow Inc. and LDPE 1I2-A from Sinopec. Results are shown in Tables 3A and 3B. In Table 3A and 3B, IE1-IE5 are inventive examples. CE1-CE13 are comparative examples. The densities of Inventive Example 4 and Comparative Example 5 and their base resin (AGILITY™ EC 7080) are measured, and all three are found to be 0.919 g/cm³; this result is consistent with our experience that irradiation at the levels used in this invention does not materially change the density of the resin.

Vinyl content and NMR branching analysis is performed as described in the Test Methods for the base resins LDPE 722, LDPE 4016, AGILITY™ EC7080, and IE1 to IE5 and CE3 and CE4. The results are shown in Table 4.

TABLE 3A

| | Units | IE1 | IE2 | IE3 | IE4 | IE5 | CE1 | CE2 | CE3 | CE4 |
|---|---|---|---|---|---|---|---|---|---|---|
| Resin | | 722 | 722 | 4016 | 4016 | AGILITY | 722 | 722 | 4016 | AGILITY |
| | | | | | | EC 7080 | | | | EC 7080 |
| Irradiation | MRad | 0.25 | 0.5 | 0.5 | 0.75 | 0.75 | 0.75 | 1.25 | 0.25 | 0.25 |
| Melt Index (I₂) | dg/ | 4.22 | 1.60 | 5.80 | 2.51 | 2.18 | 0.64 | 0.10 | 11.4 | 5.46 |
| | min | | | | | | | | | |
| Melt Strength | cN | 15.8 | 31.1 | 18.9 | 26 | 22.8 | 21.2 | 26.9 | 8.9 | 8 |
| Melt Strength/ | cN/(dg/ | 3.7 | 19.4 | 3.3 | 10.4 | 10.5 | 33.2 | 281.4 | 0.8 | 1.5 |
| Melt Index | min.) | | | | | | | | | |
| Conventional Mₙ | Kg/mol | 15.3 | 15.1 | 14.7 | 14.7 | 13.1 | 12.0 | 9.4 | 15.1 | 13.3 |
| Conventional M_{w} | Kg/mol | 211 | 220 | 214 | 261 | 158 | 185 | 109 | 178 | 115 |
| M_{w(Conv)}/M_{n (Conv)} | n/a | 13.8 | 14.6 | 14.6 | 17.7 | 12.0 | 15.5 | 11.6 | 11.9 | 8.69 |
| Absolute M_{w} | Kg/mol | 768 | 890 | 858 | 1250 | 473 | 743 | 361 | 602 | 303 |
| M_{w (Abs)}/M_{w (Conv)} | n/a | 3.63 | 4.05 | 4.00 | 4.77 | 2.99 | 4.01 | 3.30 | 3.37 | 2.62 |
| LCBf | LCB/ | 3.82 | 6.78 | 5.54 | 7.55 | 3.75 | 5.93 | 5.26 | 3.50 | 2.88 |
| | 1000C | | | | | | | | | |
| Branching Index | | 0.557 | 0.485 | 0.513 | 0.477 | 0.543 | 0.511 | 0.567 | 0.577 | 0.580 |
| (g′) | | | | | | | | | | |
| gpcBR | | 5.48 | 6.22 | 6.33 | 7.95 | 3.76 | 5.86 | 4.17 | 5.10 | 3.01 |
| Viscosity Ratio | | 11.4 | 17.0 | 9.45 | 12.2 | 17.8 | 20.3 | — | 6.8 | 10.8 |
| Tan-δ | | 3.5 | 2.1 | 3.6 | 2.6 | 2.5 | 1.7 | — | 6.9 | 5.2 |
| GPC Recovery | Wt % | 106 | 101 | 108 | 100 | 104 | 44 | 46 | 104 | 104 |
| Gel Content | Wt % | −0.39 | −0.33 | — | — | — | 2.9 | — | — | — |

TABLE 3B

| | Units | CE5 | CE6 | CE7 | CE8 | CE9 | CE10 | CE11 | CE12 | CE13 |
|---|---|---|---|---|---|---|---|---|---|---|
| Resin | | 780E | 780E | 993I | 993I | 955I | 955I | 621I | 662I | 1I2-A |
| Irradiation | MRad | 0.25 | 0.75 | 0.75 | 1.25 | 0.75 | 1.25 | — | — | — |
| Melt Index (I₂) | dg/ | 16.3 | 12.0 | 13.7 | 9.27 | 24.8 | 21.5 | 2.30 | 0.50 | 1.78 |
| | min | | | | | | | | | |
| Melt Strength | cN | 1.0 | 2.6 | 5.0 | 8.2 | 1 | 0.5 | 15.5 | 27.5 | 25 |
| Melt Strength/ | cN/(dg/ | 0.1 | 0.2 | 0.4 | 0.9 | 0.04 | 0.02 | 6.7 | 54.4 | 14.0 |
| Melt Index | min.) | | | | | | | | | |
| Conventional Mₙ | Kg/mol | 12.8 | 13.2 | 13.9 | 13.8 | 17.4 | 18.6 | 22.0 | 25.5 | 23.1 |
| Conventional M_{w} | Kg/mol | 70.6 | 75.8 | 113 | 122 | 50.9 | 56.7 | 224 | 104 | 261 |
| M_{w(Conv)}/M_{n (Conv)} | n/a | 5.5 | 6.22 | 8.13 | 9.06 | 2.93 | 3.25 | 10.2 | 8.24 | 11.3 |
| Absolute M_{w} | Kg/mol | 158 | 166 | 316 | 366 | 112 | 126 | 799 | 195 | 1050 |
| M_{w(abs)}/M_{w(conv)} | n/a | 2.25 | 2.19 | 2.79 | 2.99 | 2.19 | 2.23 | 3.57 | 1.88 | 4.03 |
| LCBf | LCB/ | 1.76 | 1.53 | 1.89 | 2.80 | 1.05 | 1.43 | 3.40 | 1.79 | 4.34 |
| | 1000C | | | | | | | | | |
| Branching Index | | 0.663 | 0.663 | 0.659 | 0.605 | 0.725 | 0.704 | — | — | — |
| (g′) | | | | | | | | | | |
| gpcBR | | 2.09 | 2.09 | 3.15 | 3.51 | 1.63 | 1.79 | 5.36 | 1.71 | 6.46 |
| Viscosity Ratio | | 3.97 | 5.52 | 5.29 | 6.53 | 2 | 2.31 | 15.5 | 24.4 | — |
| Tan-δ | | 27.2 | 13.4 | 9.59 | 8.2 | 80.0 | 62.0 | 3 | 1.62 | — |
| GPC Recovery | Wt % | 107 | 110 | 99 | 104 | 102 | 103 | 100 | 100 | 97 |

| | | | 1H NMR Data | | | | | C13 NMR Data | | | | | |
|---|---|---|---|---|---|---|---|---|---|---|---|---|---|
| | | | C/T | Trisub- | | | | | | | | | 38.2 |
| | | | vinyl | sti- | | Vinyl- | Total | Gem- | 1,3- | | | | ppm |
| | Resin | EBeam | enes | tuted | Vinyls | idenes | Unsat | diethyls | diethyls | C4 | C5 | C6+ | Peak |
| Ex | Units | MRad | Units/1000 Carbon | | | | | Units/1000 Carbon | | | | | |
| Base | 722 | — | 0.036 | 0.026 | 0.037 | 0.222 | 0.321 | 2.4 | 5.1 | 7.9 | 2.5 | 3.8 | 10.18 |
| IE1 | 722 | 0.25 | 0.041 | 0.022 | 0.026 | 0.194 | 0.283 | 2.2 | 5.4 | 8.0 | 2.4 | 3.8 | 10.24 |
| IE2 | 722 | 0.5 | 0.045 | 0.022 | 0.025 | 0.186 | 0.278 | 2.1 | 5.3 | 7.9 | 2.5 | 3.8 | 10.33 |
| Base | 4016 | — | 0.049 | 0.030 | 0.035 | 0.205 | 0.319 | 2.0 | 4.7 | 7.9 | 2.4 | 4.0 | 10.16 |
| CE3 | 4016 | 0.25 | 0.045 | 0.021 | 0.042 | 0.198 | 0.306 | 2.1 | 5.5 | 7.7 | 2.5 | 4.0 | 10.35 |
| IE3 | 4016 | 0.5 | 0.047 | 0.021 | 0.029 | 0.179 | 0.276 | 2.1 | 5.2 | 8.0 | 2.4 | 3.9 | 10.32 |
| IE4 | 4016 | 0.75 | 0.052 | 0.021 | 0.025 | 0.169 | 0.267 | 2.0 | 5.2 | 8.1 | 2.4 | 3.9 | 10.77 |
| Base | AGIL- | — | 0.060 | 0.032 | 0.071 | 0.234 | 0.397 | 2.1 | 5.0 | 7.5 | 2.3 | 4.4 | 10.13 |
| | ITY EC | | | | | | | | | | | | |
| | 7080 | | | | | | | | | | | | |
| CE4 | AGIL- | 0.25 | 0.060 | 0.030 | 0.065 | 0.210 | 0.365 | 2.0 | 5.1 | 7.7 | 2.5 | 4.7 | 10.26 |
| | ITY EC | | | | | | | | | | | | |
| | 7080 | | | | | | | | | | | | |
| IE5 | AGIL- | 0.75 | 0.067 | 0.028 | 0.041 | 0.176 | 0.312 | 1.9 | 5.1 | 7.9 | 2.7 | 4.8 | 10.39 |
| | ITY EC | | | | | | | | | | | | |
| | 7080 | | | | | | | | | | | | |

1. A process to modify a low density polyethylene (LDPE) resin, which process comprises the steps of:
a) Providing a starting LDPE resin having:
i) A density from 0.91 g/cm³ to 0.94 g/cm³;
ii) A melt-index (I₂) from 5 dg/min to 18 dg/min; and
iii) A conventional molecular weight distribution (M_{w (Conv)}/M_{n (Conv)}) of at least 6; and
b) Irradiating the starting LDPE resin with an electron-beam at an intensity and for a time effective to provide a modified LDPE resin having:
i) A melt-index (I₂) of at least 1 dg/min; and
ii) A conventional molecular weight distribution (M_{w (Conv)}/M_{n (Conv)}) of at least 10; and
iii) A melt strength of at least 15 cN; and
iv) A GPC mass recovery of at least 95 percent.

2. The process of claim 1 wherein the starting LDPE resin receives an average dosage of 0.25 MRad to 1.25 MRad.

3. The process of claim 1 wherein the starting LDPE resin receives an average dosage of 0.45 MRad to 1.0 MRad.

4. The process in claim 1 wherein the starting LDPE resin has a melt-index (I₂) from 5 dg/min to 17 dg/min.

5. The process in claim 1 wherein the conventional molecular weight distribution (M_{w (Conv)}/M_{n (Conv)}) of the modified LDPE resin is from 140% to 200% of the molecular weight distribution of the starting LDPE resin.

6. The process in claim 1 wherein the melt-strength of the modified LDPE resin is at least 10 cN higher than the melt strength of the starting LDPE resin.

7. The process in claim 1 wherein the melt-index of the modified LDPE resin is at least 20% of the melt index of the starting LDPE resin.

8. The process in claim 1 wherein the starting LDPE resin is a product from a tubular reactor system.

9. A LDPE resin having the following properties:
a) A density from 0.91 g/cm³ to 0.94 g/cm³;
b) A melt-index (12) from 1.5 dg/min to 6 dg/min; and
c) A conventional molecular weight distribution (M_{w (Conv)}/M_{n (Conv)}) from 10 to 20; and
d) A melt strength of at least 25 cN; and
e) A GPC mass recovery of at least 95 percent.

10. The invention in claim 1 wherein the modified LDPE resin has a gpcBR of at least 3.75.

11. The invention in claim 1 wherein the modified LDPE resin has a ratio of (M_{w (Abs)})/(M_{w (Conv)}) of at least 3.

12. The invention in claim 1 wherein the modified LDPE resin has a viscosity ratio at 190° C. of at least 9.

13. The invention in claim 1 wherein the ratio of melt strength (in cN) to melt index (in dg/min) of the modified LDPE resin is from 2 to 25.

14. A polymer blend containing (a) the modified LDPE resin in claim 1 and (2) a high-density polyethylene resin, linear-low density polyethylene resin, or another low density polyethylene.

15. A fabricated article containing the modified LDPE resin in claim 1, which fabricated articles is an extruded single layer or multilayer film and sheet, an extruded coating or a foamed article.
